(19) United States
(12) Patent Application Publication
(10) Pub. No.: US 2025/0299045 A1
(43) Pub. Date: Sep. 25, 2025

(54) OPERATION METHOD LEARNING SYSTEM, OPERATION METHOD LEARNING METHOD, AND STORAGE MEDIUM

(71) Applicant: HONDA MOTOR CO., LTD., Tokyo (JP)

(72) Inventors: Naoki Morihira, Wako-shi (JP); Akinobu Hayashi, Wako-shi (JP)

(21) Appl. No.: 19/074,486

(22) Filed: Mar. 10, 2025

(30) Foreign Application Priority Data
Mar. 21, 2024 (JP) 2024-045230

(51) Int. Cl. G06N 3/088; G06N 3/008; G06N 3/0442

(52) U.S. Cl. CPC G06N 3/088; G06N 3/008; G06N 3/0442

(57) ABSTRACT

An operation method learning system acquires observed data of a robot at a first time, calculates a first feature amount based on the observed data using a first encoder, calculate a second feature amount at the first time based on an action of the robot at a second time, a second feature amount at the second time, and the first feature amount at the first time using a recursive second encoder that holds the second feature amount at the second time, determines an action of the robot at the first time on the basis of the second feature amount at the first time, and learns at least the first encoder and the second encoder using contrastive learning.

### CROSS-REFERENCE TO RELATED APPLICATION

This application is based upon and claims the benefit of priority from Japanese Patent Application No. 2024-045230, filed Mar. 21, 2024, the entire content of which is incorporated herein by reference.

### BACKGROUND

### Field of the Invention

The present invention relates to an operation method learning system, an operation method learning method, and a storage medium.

### Description of Related Art

Conventionally, to operate or recognize an object grasped by a robot hand (also called an end effector), or to recognize the object itself, a matching-based recognizer using control by planning based on a model designed by humans or an object model has been used. In recent years, there are many approaches that use data-driven learning methods to acquire planners and recognizers.

Planning methods designed by humans and matching-based recognition methods that use object model information can be limitedly applied to some cases, and do not have high performance in terms of robustness and generalization performance. On the other hand, methods that use data-driven learning are known to have high robustness and generalization performance within a range included in learning data.

### SUMMARY

However, when information from a tactile sensor mounted on a robot is used as input information for a learning-based planner or recognizer (hereinafter referred to as a machine learning model), only information on a position with which the object is in contact is obtained, so that the information is likely to be partial (that is, sparse). In addition, even when a camera is used, there are cases where only sparse information is easily obtained due to occlusion of a target object by the robot itself or obstacles. In such cases, it may be difficult to learn a machine learning model or performance may deteriorate.

The present invention has been made in consideration of these circumstances, and one of its objectives is to provide an operation method learning system, an operation method learning method, and a storage medium that can execute a target task robustly and with high accuracy using a machine learning model even if information input to the machine learning model is partial observation (sparse).

The operation method learning system, the operation method learning method, and the storage medium according to the present invention have adopted the following configuration.
(1) According to a first aspect of the present invention, an operation method learning system includes an acquisition unit configured to acquire observed data indicating an observation result of a state of a robot capable of operating an object at a first time, a first calculation unit configured to calculate a first feature amount at the first time based on the observed data at the first time using a first encoder, a second calculation unit configured to calculate a second feature amount at the first time based on an action of the robot at a second time, a second feature amount at the second time, and the first feature amount at the first time using a recursive second encoder that holds the second feature amount at the second time prior to the first time, a determination unit configured to determine an action of the robot at the first time on the basis of the second feature amount at the first time, and a learning unit configured to learn at least the first encoder and the second encoder using contrastive learning.
(2) According to a second aspect of the present invention, in the first aspect, the learning unit may learn at least the first encoder and the second encoder as the contrastive learning so that the second feature amount calculated using the second encoder approaches a first target feature amount and the second feature amount moves away from a second target feature amount.
(3) According to a third aspect of the present invention, in the second aspect, the learning unit may extract the observed data at a first reference time and the observed data at a second reference time prior to the first reference time from the time-series observed data including the observed data at the first time and the second time, input at least the observed data at the first reference time to a third encoder, set a latent variable output by the third encoder in response to the input of the observed data at the first reference time as the first target feature amount, input the observed data at the second reference time to the third encoder, and set the latent variable output by the third encoder in response to the input of at least the observed data at the second reference time as the second target feature amount.
(4) According to a fourth aspect of the present invention, in the third aspect, the determination unit may determine an action of the robot at the first time using reinforcement learning, and the learning unit may learn the first encoder and the second encoder using a reward of the reinforcement learning.
(5) According to a fifth aspect of the present invention, in the fourth aspect, the learning unit may further input the reward at the first reference time to the third encoder, in addition to the observed data at the first reference time, set the latent variable output by the third encoder in response to the input of the observed data and the reward at the first reference time as the first target feature amount, further input the reward at the second reference time to the third encoder, in addition to the observed data at the second reference time, and set the latent variable output by the third encoder in response to the input of the observed data and the reward at the second reference time as the second target feature amount.
(6) According to a sixth aspect of the present invention, in the first or second aspect, the first calculation unit may input the observed data at the first time to the first encoder, and calculate a latent variable output by the first encoder in response to the input of the observed data at the first time as the first feature amount at the first time.
(7) According to a seventh aspect of the present invention, in the first or second aspect, the second calculation unit may input the first feature amount at the first time to the second encoder, and calculate a latent variable output by the second encoder in response to the input of the first feature amount at the first time as the second feature amount at the first time.
(8) According to an eighth aspect of the present invention, an operation method learning method includes acquiring observed data indicating an observation result of a state of a robot capable of operating an object at a first time, calculating a first feature amount at the first time based on the observed data at the first time using a first encoder, calculating a second feature amount at the first time based on an action of the robot at a second time, a second feature amount at the second time, and the first feature amount at the first time using a recursive second encoder that holds the second feature amount at the second time prior to the first time, determining an action of the robot at the first time on the basis of the second feature amount at the first time, and learning at least the first encoder and the second encoder using contrastive learning.
(9) According to a ninth aspect of the present invention, a non-transitory storage medium has stored a program for causing a computer to execute acquiring observed data indicating an observation result of a state of a robot capable of operating an object at a first time, calculating a first feature amount at the first time based on the observed data at the first time using a first encoder, calculating a second feature amount at the first time based on an action of the robot at a second time, a second feature amount at the second time, and the first feature amount at the first time using a recursive second encoder that holds the second feature amount at the second time prior to the first time, determining an action of the robot at the first time on the basis of the second feature amount at the first time, and learning at least the first encoder and the second encoder using contrastive learning.

According to the aspects described above, it is possible to execute a target task robustly and with high accuracy using a machine learning model even if information input to the machine learning model is partial observation (sparse).

### BRIEF DESCRIPTION OF THE DRAWINGS

FIG. 1 is a diagram which schematically shows appearance of a robot included in an operation method learning system according to an embodiment.

FIG. 2 is a schematic diagram of the operation method learning system according to the embodiment.

FIG. 3 is a flowchart which shows a series of processing in a processing unit according to the embodiment.

FIG. 4 is a diagram which schematically represents processing content of the processing unit according to the embodiment.

FIG. 5 is a diagram which schematically shows how to learn each encoder using two approaches, using two approaches, contrastive learning and deep reinforcement learning.

FIG. 6 is a diagram which represents an example of a task.

FIG. 7 is a diagram which represents an example of a task.

FIG. 8 is a diagram which represents an example of a task.

FIG. 9 is a diagram which represents an example of a task.

FIG. 10 is a diagram which represents results of a comparison between a learning method of the present embodiment and other methods for each task.

FIG. 11 is a diagram which represents results of a comparison between the learning method of the present embodiment and other methods for each task.

FIG. 12 is a diagram which represents results of a comparison between the learning method of the present embodiment and other methods for each task.

FIG. 13 is a diagram which represents results of a comparison between the learning method of the present embodiment and other methods for each task.

### DESCRIPTION OF EMBODIMENTS

Hereinafter, the operation method learning system, the operation method learning method, and the storage medium of the present invention will be described with reference to the drawings.

### [Appearance of Robot]

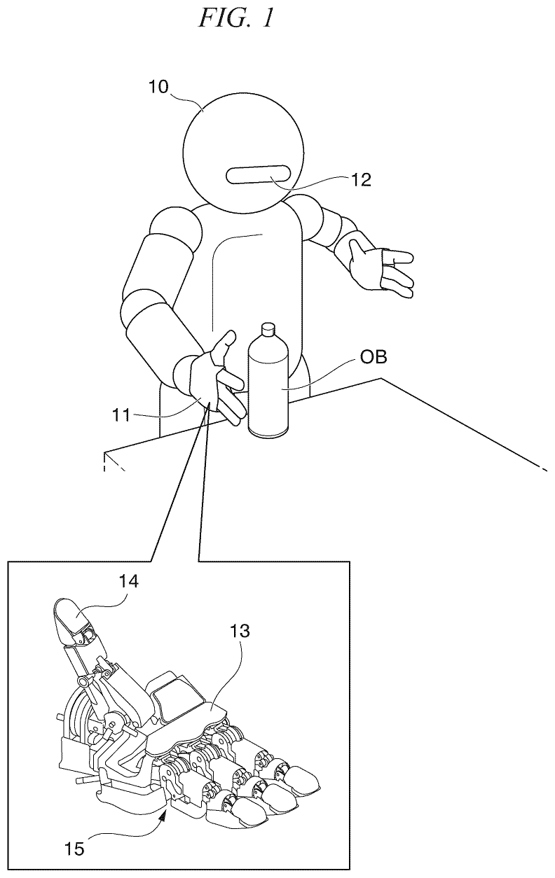

FIG. 1 is a diagram that schematically represents an appearance of a robot 10 included in an operation method learning system 1 according to an embodiment. The robot 10 is typically a humanoid robot that can grasp or operate an object OB using an end effector 11, but is not limited to this and may be any type of robot that can grasp or operate the object OB. For example, the robot 10 may be a quadrupedal animal-type robot, or may be any other type of robot.

The end effector 11 is also called a robot hand. The end effector 11 may be provided with, for example, several fingers (a thumb finger, an index finger, a middle finger, a ring finger, and the like) as grippers.

The end effector 11 is provided with a plurality of tactile sensors 13, a plurality of force sensors 14, a plurality of posture sensors 15, and the like.

The tactile sensors 13 are distributed and arranged on, for example, a palm of the end effector 11. Specifically, a total of 224 tactile sensors 13 may be arranged on the palm of the end effector 11. In other words, the tactile sensors 13 may detect forces applied onto the palm using the total of 224 channels. Each channel of the tactile sensor 13 is called a tactile pixel, also known as a taxel.

The force sensors 14 are arranged, for example, at each fingertip of the end effector 11, and detects forces (loads) of three axes (X, Y, Z) applied to each fingertip and moments (torques) around each axis. For example, when the end effector 11 is provided with a thumb finger, an index finger, a middle finger, and a ring finger, the force sensors 14 are arranged one at each finger to detect forces and moments using a total of 4×6=24 channels.

The posture sensors 15 are arranged at, for example, each finger of the end effector 11 and detect a posture of each finger. The posture detected by the posture sensor 15 is typically a joint angle of each finger, but is not limited to this, and may be an angular velocity or torque of the joint angle, or a combination of these. In the following description, as an example, the posture detected by the posture sensor 15 is described as a joint angle.

For example, if the end effector 11 is provided with a thumb finger, an index finger, a middle finger, and a ring finger, and each finger is further provided with four joints, the posture sensor 15 detects joint angles using a total of 4×4=16 channels.

The number of tactile sensors 13 is not limited to 224, and may be any number, for example, from several tens to several hundreds. Similarly, the number of force sensors 14 and posture sensors 15 may also be any number.

In addition to the end effector 11, the robot 10 may further include a visual sensor 12 for imaging an external environment or working space seen by the robot 10, a control device 100 for controlling an operation of the robot 10, and the like. The robot 10 executes a target task according to an action determined by the control device 100.

A task is, for example, grabbing the object OB with the end effector 11, transferring the object OB to the other end effector 11, or moving the object OB. Note that the task is not limited to these, and any task can be set.

The visual sensor 12 is installed in a part of the body of the robot 10 (typically the head). The visual sensor 12 may be, for example, a depth camera (3D camera). For example, the visual sensor 12 captures an image of a scene in which the object OB is grasped or operated by the end effector 11, and transmits image data of the scene to the control device 100, or transmits the image data to an external device (for example, a human-machine interface) via the control device 100. The visual sensor 12 is not limited to a depth camera, and may be, for example, a sensor that images an external environment by radiating electromagnetic waves such as a radar or a lidar.

Furthermore, the image data described above may be image data generated by an external camera (not shown) installed in the working space of the robot 10 in addition to or instead of image data of the visual sensor 12 installed in the robot 10. The external camera installed in the working space of the robot 10 may be used to perform image analysis such as pattern matching. The image analysis may be image analysis that extracts the object OB from a video.

The control device 100 controls the robot 10 to execute a target task using, for example, data indicating detection results of various sensors (the tactile sensor 13, the force sensor 14, and the posture sensor 15) provided on the end effector 11 and the visual sensor 12. In the present embodiment, the control device 100 compresses dimensions of data of the various sensors provided on the robot 10 using a plurality of encoders, and determines an action of the robot 10 to realize a given task using the compressed data. At this time, the processing unit 120 learns the plurality of encoders by introducing contrastive learning.

The control device 100 may typically be mounted on the robot 10. Moreover, instead of being mounted on the robot 10, the control device 100 may be installed at a location far away from the robot 10 and control the robot 10 remotely via a network NW. The network NW includes, for example, a local area network (LAN) and a wide area network (WAN).

### [Configuration of Robot and Control Device]

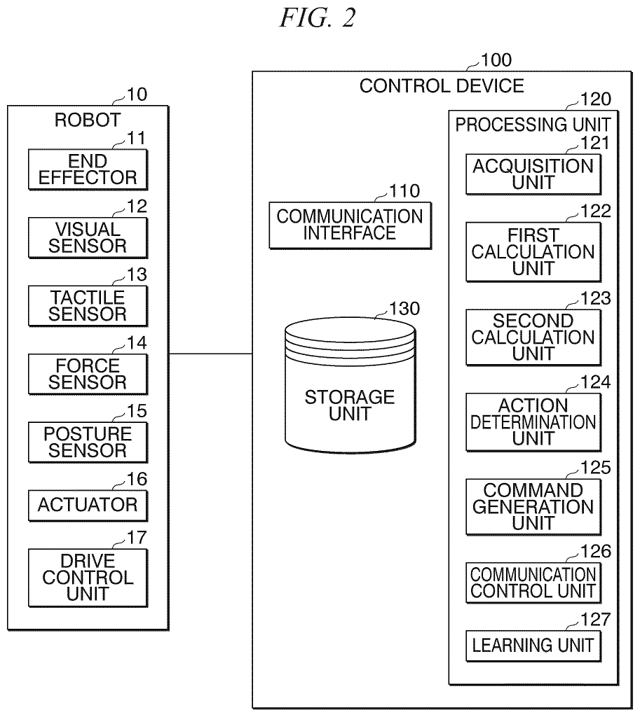

FIG. 2 is a configuration diagram of an operation method learning system 1 according to an embodiment. The operation method learning system 1 includes, for example, a robot 10 and a control device 100. In addition to the end effector 11, the visual sensor 12, the tactile sensor 13, the force sensor 14, and the posture sensor 15 described above, the robot 10 further includes an actuator 16 and a drive control unit 17.

The actuator 16 drives each part of the robot 10 (arms, fingers, legs, head, torso, waist, or the like) under the control of the drive control unit 17. The actuator 16 includes, for example, an electromagnetic motor, a gear, an artificial muscle, and the like.

The drive control unit 17 controls the actuator 16 on the basis of a control command generated by the control device 100.

The control device 100 includes, for example, a communication interface 110, a processing unit 120, and a storage unit 130.

The communication interface 110 communicates with the robot 10 via a communication line such as a bus, and communicates with external devices via a network NW. The communication interface 110 includes, for example, a wireless communication module including a receiver and a transmitter, a network interface card (NIC), and the like.

The processing unit 120 includes, for example, an acquisition unit 121, a first calculation unit 122, a second calculation unit 123, an action determination unit 124, a command generation unit 125, a communication control unit 126, and a learning unit 127.

Components of the processing unit 120 are realized by, for example, a central processing unit (CPU) or a graphics processing unit (GPU) executing a program stored in the storage unit 130. Some or all of these components may be realized by hardware such as a large scale integration (LSI), an application specific integrated circuit (ASIC), a field programmable gate array (FPGA), or a system on chip (SOC), or may be realized by software and hardware in cooperation.

The storage unit 130 is realized by, for example, a hard disk drive (HDD), a flash memory, an electrically erasable programmable read only memory (EEPROM), a read only memory (ROM), a random access memory (RAM), or the like. The storage unit 130 stores model data in addition to various types of programs such as firmware and application programs. The model data is data (programs or algorithms) that define several machine learning models for determining the action of the robot 10. For example, the model data defines a query encoder MDL1, a temporal encoder MDL2, a key encoder MDL3, a deep reinforcement learning model MDL4, and the like, which will be described below. The model data may be installed, for example, in the storage unit 130 from an external device via the network NW, or may be installed in the storage unit 130 from a portable storage medium connected to a drive device of the control device 100.

### [Processing Flow]

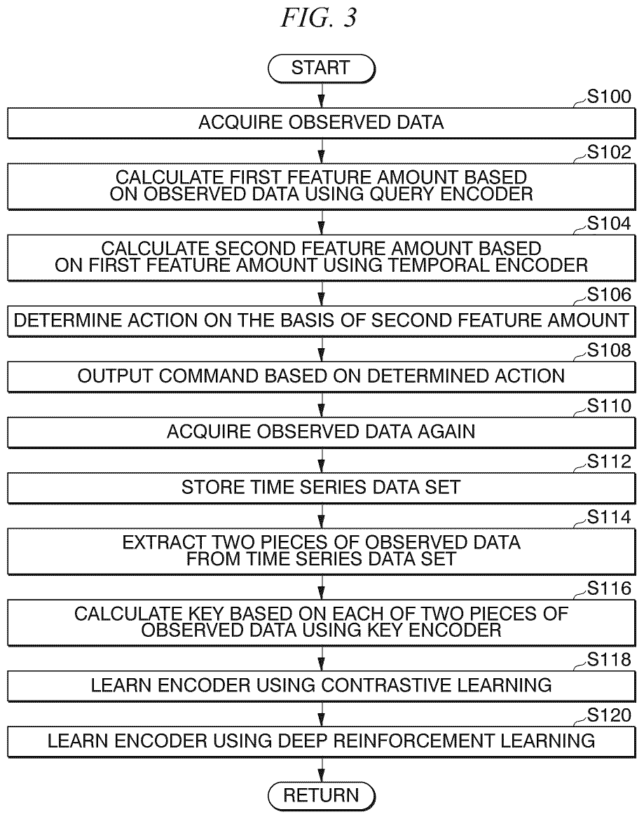

Processing content of the processing unit 120 will be described below using a flowchart and a schematic diagram. FIG. 3 is a flowchart which represents a flow of a series of processing steps of the processing unit 120 according to the embodiment. FIG. 4 is a diagram which represents the processing content of the processing unit 120 according to the embodiment. The processing of this flowchart may be repeatedly executed until the target task is realized. More specifically, it may be repeatedly executed until a reward r of the reinforcement learning described below converges.

First, the acquisition unit 121 acquires observed data Oₜ at a time t from the robot 10 placed in an environmental state sₜ at the time t to be processed (step S100). The time t is an example of a “first time”.

The observed data Oₜ is multidimensional data in which data indicating a force and a moment detected by the tactile sensor 13 and the force sensor 14 at the time t (hereafter referred to as tactile data) and data indicating a posture (a joint angle) detected by the posture sensor 15 at the same time t (hereafter referred to as posture data) are combined.

The tactile data is represented as a 248-dimensional vector which is a sum of detection results of the tactile sensors 13 distributed on the palm (=224 dimensions) and detection results of 6-axis force sensors 14 of each finger (=4 fingers×6 axes=24 dimensions).

The posture data is represented as a 16-dimensional vector of detection results of the posture sensors 15 of each finger (=4 fingers×4 the number of joints).

Therefore, the observed data Oₜ is represented as a multidimensional vector with 248+16=264 dimensions. The number of dimensions of the observed data Oₜ is not limited to 264, and may vary depending on the number of sensors and the number of physical finger marks to be detected.

Next, the first calculation unit 122 uses the query encoder MDL1 to calculate a first feature amount at the time t based on the observed data Oₜ acquired by the acquisition unit 121. MDL is simply a code that represents an abbreviation of MODEL.

The query encoder MDL1 is a machine learning model that is learned to compress dimensions of input data, and may be implemented by, for example, a multi-layer perceptron (MLP) or convolutional neural network (CNN).

The first calculation unit 122 inputs the observed data Oₜ to the query encoder MDL1. In response to the input of the observed data Oₜ, the query encoder MDL1 outputs a first latent variable vector having fewer dimensions than the observed data Oₜ. In other words, the query encoder MDL1 embeds the observed data Oₜ in the first latent space as a first latent variable vector.

The first calculation unit 122 calculates the first latent variable vector output by the query encoder MDL1 as the first feature amount at the time t. The query encoder MDL1 is an example of a “first encoder.”

Next, the second calculation unit 123 uses the temporal encoder MDL2 that performs recursive processing to calculate a second feature amount at the time t based on an action aₜ₋₁ of the robot 10 at a time t−1, which is prior to the time t, a second feature amount at the time t−1, and the first feature amount at the time t calculated by the first calculation unit 122. Time t−1, which is prior to the time t, is an example of a “second time.”

The temporal encoder MDL2 is a machine learning model that is learned to compress the dimensions of input data, and may be implemented by, for example, combining two types of machine learning models. In the following description, a first temporal encoder MDL2 is referred to as a first temporal encoder MDL2-1, and a second temporal encoder MDL2 is referred to as a second temporal encoder MDL2-2. The temporal encoder MDL2 is an example of a “second encoder.”

For example, the first temporal encoder MDL2-1 may be implemented by a recurrent neural network (RNN) including a long short-term memory (LSTM), and the second temporal encoder MDL2-2 may be implemented by an MLP. The LSTM temporarily holds the second feature amount at the time t−1. The second feature amount held in the LSTM is repeatedly updated recursively.

The second calculation unit 123 inputs the first feature amount at the time t (that is, the first latent variable vector) and the action aₜ₋₁ of the robot 10 at the time t−1 to the first temporal encoder MDL2-1. When the first temporal encoder MDL2-1 receives the first latent variable vector at the time t and the action aₜ₋₁ of the robot 10 at a time t−1, it outputs a second latent variable vector having fewer dimensions than the first latent variable vector and the action aₜ₋₁ on the basis of the input first latent variable vector and the action aₜ₋₁ and the second feature amount at the time t−1 held in the LSTM. In other words, the first temporal encoder MDL2-1 embeds the first latent variable vector and the action aₜ₋₁ in the second latent space as a second latent variable vector.

The second calculation unit 123 further inputs the second latent variable vector output by the first temporal encoder MDL2-1 to the second temporal encoder MDL2-2. In response to the input of the second latent variable vector at the time t, the second temporal encoder MDL2-2 outputs a third latent variable vector having fewer dimensions than the second latent variable vector. In other words, the second temporal encoder MDL2-2 embeds the second latent variable vector in the third latent space as the third latent variable vector. In particular, the third latent variable vector is also called a query q.

The second calculation unit 123 calculates the third latent variable vector at the time t (a query qₜ at the time t) output by the second temporal encoder MDL2-2 as the second feature amount at the time t.

Next, the action determination unit 124 determines an action at of the robot 10 at the time t on the basis of the second feature amount at the time t (that is, the query qₜ) (step S106).

For example, the action determination unit 124 may determine the action at of the robot at the time t using the deep reinforcement learning model MDL4.

The deep reinforcement learning model MDL4 may be, for example, an Actor-Critic in which a value and a policy are combined. Examples of the Actor-Critic include, for example, Twin Delayed DDPG (TD3), Soft Actor-Critic (SAC), and Proximal Policy Optimization (PPO). In the present embodiment, the deep reinforcement learning model MDL4 is described as TD3, which is one of the Actor-Critics, as an example.

For example, the action determination unit 124 does not input an observed data Oₜ, which indicates detection results of an environmental state sₜ detected by various sensors at the time t, into the deep reinforcement learning model MDL4 as it is, but compresses the observed data Oₜ into a low dimension using the query encoder MDL1 and the temporal encoder MDL2 and then inputs it into the deep reinforcement learning model MDL4. In response to this, the deep reinforcement learning model MDL4 outputs an action (action variable) with a maximum value (Q value) among one or more actions (action variables) at that the robot 10 can take under the environmental state sₜ at the time t. A reward rₜ is added to the value. The reward n, is calculated using a reward function R (sₜ₋₁, aₜ₋₁) with the environmental state sₜ₋₁ and action aₜ₋₁ at the time t−1, which are prior to the time t, as explanatory variables. The action (action variable) at may be, for example, a variety of actions such as grabbing, switching, or moving the object OB with the end effector 11.

Next, the command generation unit 125 generates a command for controlling each actuator 16 of the robot 10 on the basis of the action at determined by the action determination unit 124, and the communication control unit 126 transmits this command to the robot 10 (step S108).

When the drive control unit 17 of the robot 10 receives a command from the control device 100, it controls the actuator 16 on the basis of the command. This causes the robot 10 to take an action so that the object OB is lifted or moved, thereby updating the environmental state sₜ surrounding the robot 10 to sₜ₊₁.

Next, the acquisition unit 121 acquires observed data Oₜ₊₁ at a time t+1 from the robot 10 placed in an environmental state sₜ₊₁ at the time t+1, which is later than the time t (step S110).

Next, the acquisition unit 121 stores a combination of the observed data Oₜ at the time t, the action aₜ at the time t, the reward function R (sₜ, aₜ) of the Actor-Critic at the time t, and the observed data Oₜ₊₁ at the time t+1 (Oₜ, aₜ, R (sₜ, aₜ), Oₜ₊₁) in the storage unit 130 as a time series data set D (step S112). The time series data set D includes past information such as (Oₜ₋₁, aₜ₋₁, R (sₜ₋₁, aₜ₋₁), Oₜ).

Next, the learning unit 127 extracts two pieces of observed data with different times from the time series data set D including the observed data Oₜ at the time t and the observed data Oₜ₋₁ at the time t−1 (step S114).

For example, the learning unit 127 may extract observed data Oₜ+j at a reference time t+j and observed data Oₜ at a time t′ prior to the reference time t+j from the time series data set D. For example, the learning unit 127 may extract observed data Oₜ₊ⱼ₋₁, which is one step prior to the observed data Oₜ₊ⱼ, or may extract observed data Oₜ₊ⱼ₋₁₀, which is 10 steps prior to the observed data Oₜ₊ⱼ as the observed data Or. The reference time t+j is an example of a “first reference time,” and the time t′ prior to the reference time t+j is an example of a “second reference time.”

Next, the learning unit 127 uses the key encoder MDL3 to calculate a fourth latent variable (hereinafter also referred to as a key k) based on the two pieces of extracted observed data Oₜ₊ⱼ and Oₜ (step S116).

The key encoder MDL3 is a machine learning model that is learned to compress the dimensions of input data, similar to the query encoder MDL1, and may be implemented by, for example, MLP or CNN. The key encoder MDL3 is an example of a “third encoder.”

First, the learning unit 127 inputs one of the two pieces of observed data Oₜ₊ⱼ and Oₜ, the observed data Oₜ₊ⱼ, to the key encoder MDL3. At this time, the learning unit 127 inputs a reward rₜ₊ⱼ at the reference time t+j in addition to the observed data Oₜ₊ⱼ. The reward rₜ₊ⱼ at the reference time t+j is calculated by a reward function R (sₜ₊ⱼ₋₁, aₜ₊ⱼ₋₁) with an environmental state sₜ₊ⱼ₋₁ at the time t+j−1 prior to the reference time t+j and an action aₜ₊ⱼ₋₁ as explanatory variables.

The key encoder MDL3 outputs a fourth latent variable vector (that is, the key k) in response to the input of the observed data Oₜ₊ⱼ and the reward rₜ₊ⱼ. In other words, the key encoder MDL3 embeds the observed data Oₜ₊ⱼ and the reward rₜ₊ⱼ as the fourth latent variable vector in a fourth latent space.

Furthermore, the learning unit 127 inputs the other of the two observed data Oₜ₊ⱼ and Oₜ, the observed data Oₜ, to the key encoder MDL3. At this time, in addition to the observed data Oₜ, the learning unit 127 also inputs a reward rₜ at a reference time t′. The reward rₜ at the reference time t′ is calculated by a reward function R (s_{t′-1}, a_{t′-1}) with an environmental state s_{t′-1} at a time t′−1 prior to the reference time t′ and an action a_{t′-1} as explanatory variables.

In response to the input of the observed data Or and the reward rₜ, the key encoder MDL3 outputs a fourth latent variable vector (that is, the key k). In other words, the key encoder MDL3 embeds the observed data Or and the reward rₜ into the fourth latent space as a fourth latent variable vector.

Next, the learning unit 127 learns the query encoder MDL1, the temporal encoder MDL2, and the key encoder MDL3 using contrastive learning (step S118).

For example, the learning unit 127 sets a fourth latent variable vector derived from one of the two pieces of observed data Oₜ₊ⱼ and O_{t′}, the observed data Oₜ₊ⱼ, as a first target latent variable vector of a positive example, and sets a fourth latent variable vector derived from the other observed data Or as a second target latent variable vector of a negative example. The first target latent variable vector is an example of a “first target feature amount,” and the second target latent variable vector is an example of a “second target feature amount.”

Then, the learning unit 127 learns the query encoder MDL1, the temporal encoder MDL2, and the key encoder MDL3 so that the query q (that is, the third latent variable vector) output by the second temporal encoder MDL2-2 approaches the first target latent variable vector of a positive example and moves away from the second target latent variable vector of a negative example.

For example, the learning unit 127 calculates a contrastive loss L_{TCL} and adjusts a parameter of each encoder (a weight coefficient or a bias component) by performing error backpropagation based on the loss L_{TCL}. The contrastive loss L_{TCL} can be represented by, for example, the following equations (1) to (3).

$$\begin{matrix}[ Equation 1 ] & \\ {ℒ}_{TCL} ( ψ ) = {ℒ}_{C} ( ψ ) + α {ℒ}_{R} ( ψ ) . & ( 1 )\end{matrix}$$

$$\begin{matrix}[ Equation 2 ] & \\ ℒ C ( ψ ) = - 𝔼 K [ log \frac{exp ( {q}_{t}^{T} W \text{?} )}{{\sum }_{{k}_{j} ∈ K} exp ( \text{?} {Wk}_{j} )} ] Θ & ( 2 )\end{matrix}$$

$$\begin{matrix}[ Equation 3 ] & \\ & ( 3 )\end{matrix}$$

$${ℒ}_{R} ( ψ ) = \frac{1}{{d}_{q}} ‖ {h}_{ψ} ( {f}_{ψ} ( \text{?} ) , {a}_{0 : t - 1} ) - \text{?} ( \text{?} ( \text{?} ) , {a}_{0 : t - 1} ) {‖}_{2}^{2} + \frac{1}{{d}_{k}} ‖ {g}_{ψ} ( {o}_{t} , \text{?} ) - \text{?} ( {o}_{t} , \text{?} ) {‖}_{2}^{2}$$

$$\text{?} \text{indicates text missing or illegible when filed}$$

w represents a parameter such as a weight coefficient or a bias component, and w′ is a moving average of the number of fingers of the parameter ψ. f_{ψ} represents the query encoder MDL1, g_{ψ} represents the key encoder MDL3, and h_{ψ} represents the temporal encoder MDL2. a is an arbitrary coefficient, for example, 1. d_{q} is the number of dimensions of the query q, and dₖ is the number of dimensions of the key k. As shown in the equation (1), the contrastive loss L_{TCL} is calculated as a sum of two types of regularization losses.

Next, the learning unit 127 uses deep reinforcement learning to learn the query encoder MDL1, the temporal encoder MDL2, and the deep reinforcement learning model MDL4 (step S120).

For example, when the deep reinforcement learning model MDL4 is Actor-Critic, the learning unit 127 calculates each of a loss of Actor L_{actor} and a loss of Critic L_{critic}, and adjusts parameters of the query encoder MDL1, the temporal encoder MDL2, and the deep reinforcement learning model MDL4 by performing error backpropagation on the basis of these two losses. This completes processing of this flowchart.

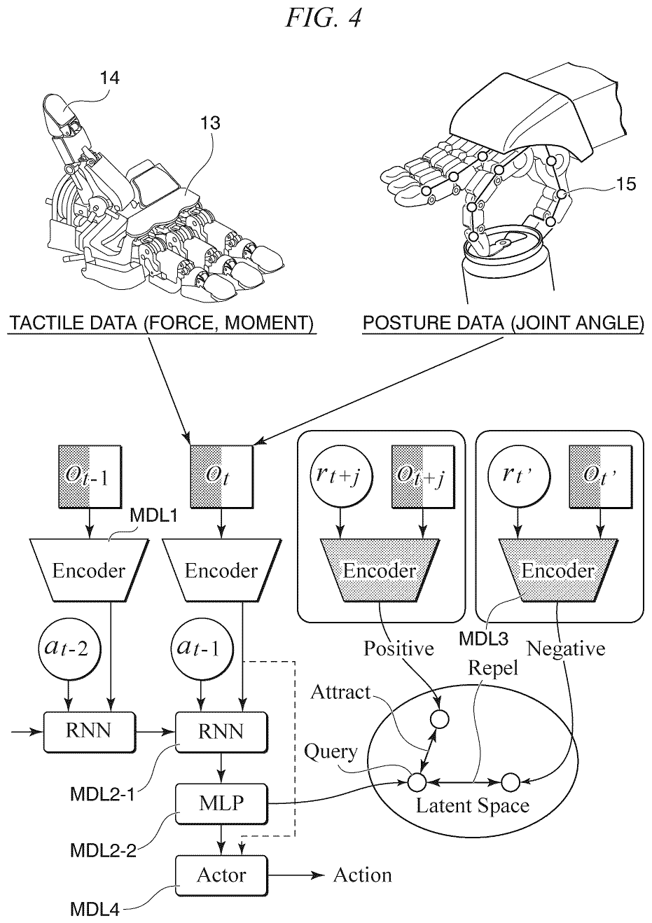

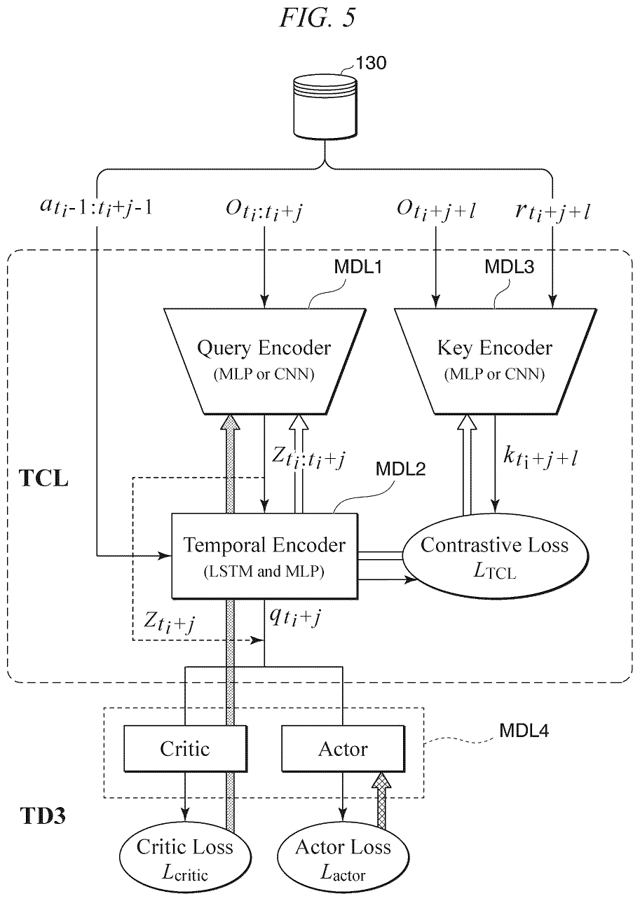

FIG. 5 is a schematic diagram which shows how each encoder is learned using two approaches of contrastive learning and deep reinforcement learning.

As shown in FIG. 5, first, the parameters of the query encoder MDL1, the temporal encoder MDL2, and the key encoder MDL3 are adjusted by a gradient based on the contrastive loss L_{TCL}. Next, parameters of Actor are adjusted by a gradient based on the loss of Actor L_{actor}, and parameters of Critic are adjusted by a gradient based on the loss of Critic L_{eritic}. Furthermore, the gradient based on the loss of Critic L_{critic} is also propagated to the query encoder MDL1 and the temporal encoder MDL2. As a result, the query encoder MDL1 and the temporal encoder MDL2 are learned once with the gradient based on the contrastive loss L_{TCL}, and then further learned with the gradient based on the loss of Critic L_{eritic}.

### [Comparison Result]

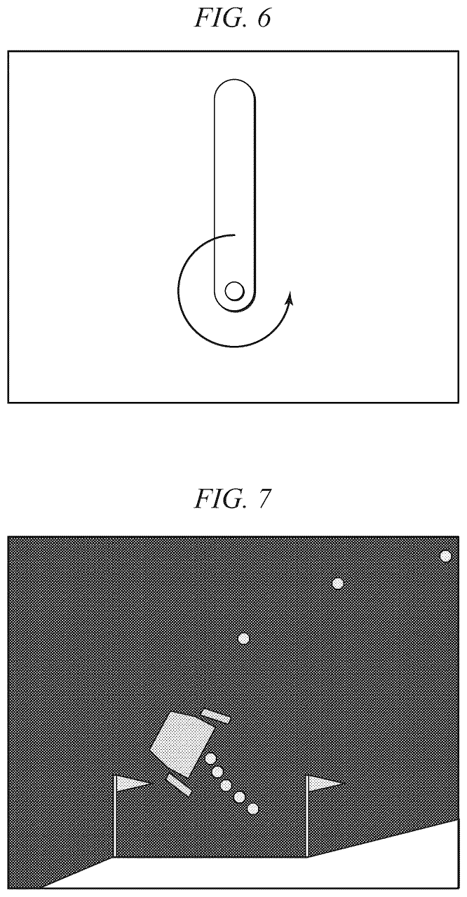

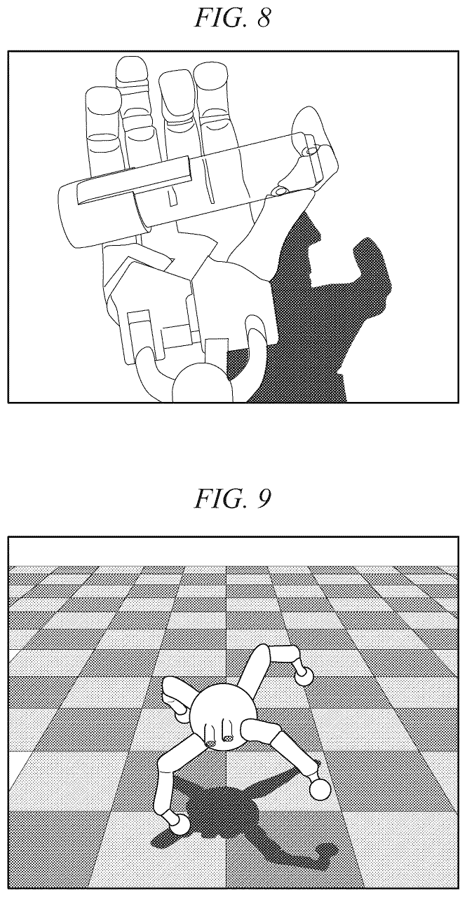

FIGS. 6 to 9 are diagrams that represent examples of tasks. FIG. 6 represents a task (hereinafter referred to as Pendulum) that operates an object OB like a pendulum, and its observed data Oₜ is represented in one dimension, and its action at is also represented in one dimension. FIG. 7 represents a task (hereinafter referred to as Lunar Lander) that lands an object OB like landing on the moon, and its observed data Oₜ is represented in five dimensions, and its action at is represented in two dimensions. FIG. 8 represents a task (hereinafter referred to as Pen (touch)) that operates an object OB like a pen, and its observed data Oₜ is represented in 51 dimensions, and its action at is represented in 24 dimensions. FIG. 9 represents a task such as quadruped walking (hereinafter referred to as Quadruped walk), and its observed data Oₜ is represented in 64×64×3 dimensions, and its action at is represented in 12 dimensions.

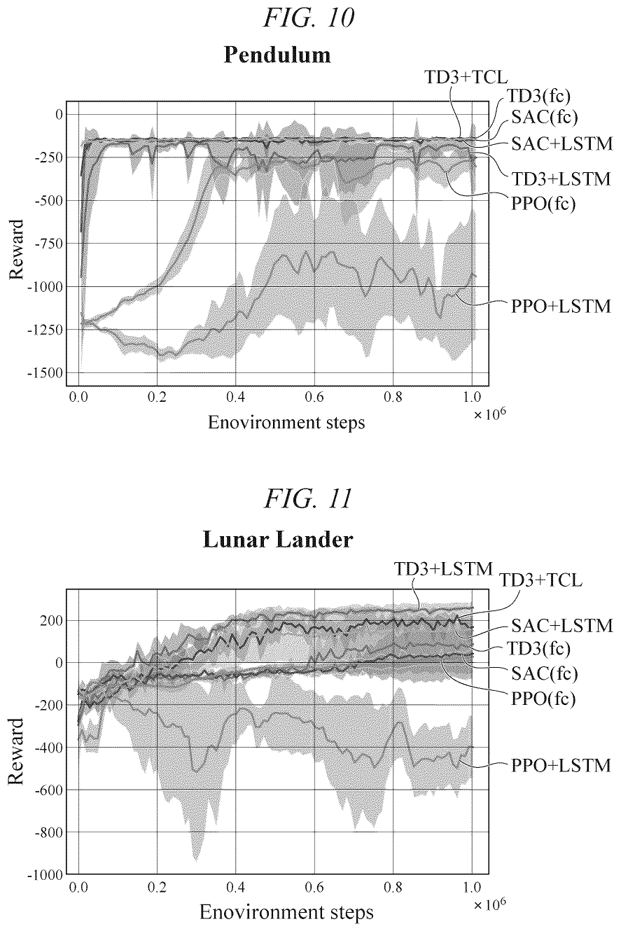

FIGS. 10 to 13 represent results of comparing the learning methods of the present embodiment with other palm methods in each task. The horizontal axis represents the number of steps at which the environment s is updated, that is, the number of times learning is repeated. The vertical axis represents the reward r.

The learning methods of the present embodiment are represented by Twin Delayed DDPG (TD3)+Temporal Contrastive Learning (TCL). Other learning methods include, for example, TD3 (fc) using a fully connected layer for TD3, TD3+LSTM using LSTM for TD3, SAC (fc) using a fully connected layer for Soft Actor-Critic (SAC), SAC+LSTM using LSTM for SAC, PPO (fc) using a fully connected layer for Proximal Policy Optimization (PPO), PPO+LSTM using LSTM for PPO, and the like.

As shown in FIG. 10, when the task is Pendulum, TD3+TCL, which is the learning method of the present embodiment, shows performance that is comparable to that of conventional TD3 (fc), SAC (fc), SAC+LSTM, or the like. Specifically, the reward r converges to a high value in a small number of steps, which means that the task is realized at an early stage.

As shown in FIG. 11, even when the task is Lunar Lander, which is more complicated than Pendulum, TD3+TCL, which is the learning method of the present embodiment, shows performance comparable to that of conventional TD3 (fc), TD3+LSTM, SAC+LSTM, or the like.

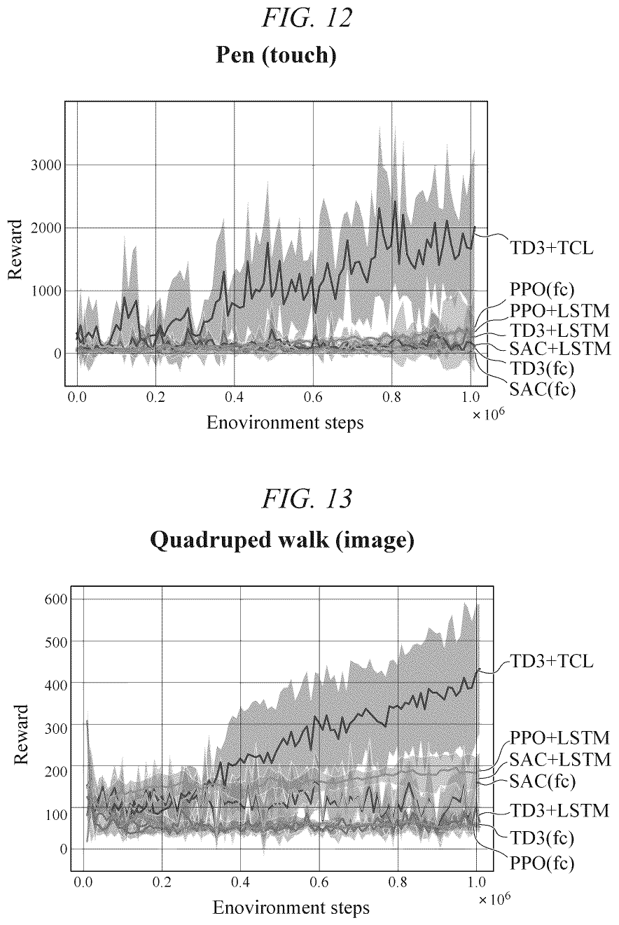

As shown in FIGS. 12 and 13, when the task is Pen (touch), which is more complicated than Lunar Lander, or Quadruped walk, which is even more complicated than Pen (touch), TD3+TCL, which is the learning method of the present embodiment, shows significantly higher performance than that of any of the conventional learning methods. Specifically, among the plurality of learning methods, the reward r converges to a high value with the fewest number of steps, which means that the task is realized at an earlier stage than the conventional learning methods. In this manner, TD3+TCL, which is the learning method of the present embodiment, introduces contrastive learning to cause each encoder to be learned in a latent space, so that even if the task becomes complex and the observed data Oₜ and action at become high-dimensional, the robot 10 can be caused to quickly execute the task.

According to the embodiment described above, the processing unit 120 of the control device 100 acquires the observed data Oₜ indicating an observation result of the environmental state sₜ of the robot 10 capable of operating an object OB at the time t. The processing unit 120 uses the query encoder MDL1 to calculate the first latent variable vector having fewer dimensions than the observed data Oₜ as the first feature amount at the time t based on the observed data Oₜ at the time t. The processing unit 120 calculates the query qₜ at the time t as the second feature amount at the time t based on the action aₜ₋₁ of the robot 10 at a time t−1, the second feature amount at the time t−1, and the first feature amount at the time t, using the temporal encoder MDL2 in which the second feature amount at the time t−1 is held in the LSTM.

The processing unit 120 uses the deep reinforcement learning model MDL4 to determine the action at of the robot 10 at the time t based on the action at of the robot at the time t. Then, the processing unit 120 learns at least the query encoder MDL1 and the temporal encoder MDL2 (the key encoder MDL3 is actually also included) using contrastive learning.

In this manner, since each encoder is learned using contrastive learning, even if information input to each encoder is only partial observation (sparse), it is possible to cause the robot 10 to execute the target task robustly and with high accuracy using the encoder. In other words, the target task becomes easier to achieve. In particular, since each encoder is learned using contrastive learning and then learned again using deep reinforcement learning, the robot 10 can be made to quickly execute a task even if the task becomes complex and the observed data Oₜ and the action at become high-dimensional, as described in the comparison with the conventional learning methods.

In addition, according to the embodiment described above, the action at of the robot 10 can be determined using only the observed data Oₜ obtained from each sensor of the end effector 11, even if a position of the object OB is not detected using a visual sensor 12, a motion capture sensor, or the like.

Furthermore, according to the embodiment described above, if an object OB of a certain shape is successfully operated, other objects having a similar shape can be operated thereafter. For example, if a rod-shaped driver is successfully operated, a similar rod-shaped pencil can also be operated using the same machine learning model (the query encoder MDL1, the temporal encoder MDL2, the key encoder MDL3, and the deep reinforcement learning model MDL4).

### Modified Example of Embodiments

In the embodiment described above, the control device 100 is described as a device for learning the query encoder MDL1, the temporal encoder MDL2, the key encoder MDL3, and the deep reinforcement learning model MDL4, but the present invention is not limited to this. For example, these models may be learned offline by a server on a network NW.

The embodiment described above can be represented as follow.

An operation method learning system includes a storage medium that stores computer-readable instructions, and a processor connected to the storage medium, wherein the processor executes the computer-readable instructions to acquire observed data indicating an observation result of a state of a robot capable of operating an object at a first time, calculate a first feature amount at the first time based on the observed data at the first time using a first encoder, calculate the second feature amount at the first time based on an action of the robot at the second time, the second feature amount at the second time, and the first feature amount at the first time using a recursive second encoder that holds a second feature amount at a second time prior to the first time, determine an action of the robot at the first time on the basis of the second feature amount at the first time, and learn at least the first encoder and the second encoder using contrastive learning.

The form for implementing the present invention has been described using an embodiment, but the present invention is not limited to such an embodiment, and various modifications and substitutions can be made within a range not departing from the gist of the present invention.

What is claimed is:

1. An operation method learning system comprising:
an acquisition unit configured to acquire observed data indicating an observation result of a state of a robot capable of operating an object at a first time;
a first calculation unit configured to calculate a first feature amount at the first time based on the observed data at the first time using a first encoder;
a second calculation unit configured to calculate a second feature amount at the first time based on an action of the robot at a second time, a second feature amount at the second time, and the first feature amount at the first time using a recursive second encoder that holds the second feature amount at the second time prior to the first time;
a determination unit configured to determine an action of the robot at the first time on the basis of the second feature amount at the first time; and
a learning unit configured to learn at least the first encoder and the second encoder using contrastive learning.

2. The operation method learning system according to claim 1,
wherein the learning unit learns at least the first encoder and the second encoder as the contrastive learning so that the second feature amount calculated using the second encoder approaches a first target feature amount and the second feature amount moves away from a second target feature amount.

3. The operation method learning system according to claim 2,
wherein the learning unit extracts the observed data at a first reference time and the observed data at a second reference time prior to the first reference time from the time-series observed data including the observed data at the first time and the second time,
inputs at least the observed data at the first reference time to a third encoder,
sets a latent variable output by the third encoder in response to the input of the observed data at the first reference time as the first target feature amount,
inputs the observed data at the second reference time to the third encoder, and
sets the latent variable output by the third encoder in response to the input of at least the observed data at the second reference time as the second target feature amount.

4. The operation method learning system according to claim 3,
wherein the determination unit determines an action of the robot at the first time using reinforcement learning, and
the learning unit learns the first encoder and the second encoder using a reward of the reinforcement learning.

5. The operation method learning system according to claim 4,
wherein the learning unit further inputs the reward at the first reference time to the third encoder, in addition to the observed data at the first reference time,
sets the latent variable output by the third encoder in response to the input of the observed data and the reward at the first reference time as the first target feature amount,
further inputs the reward at the second reference time to the third encoder, in addition to the observed data at the second reference time, and
sets the latent variable output by the third encoder in response to the input of the observed data and the reward at the second reference time as the second target feature amount.

6. The operation method learning system according to claim 1,
wherein the first calculation unit inputs the observed data at the first time to the first encoder, and
calculates a latent variable output by the first encoder in response to the input of the observed data at the first time as the first feature amount at the first time.

7. The operation method learning system according to claim 1,
wherein the second calculation unit inputs the first feature amount at the first time to the second encoder, and
calculates a latent variable output by the second encoder in response to the input of the first feature amount at the first time as the second feature amount at the first time.

8. An operation method learning method comprising:
acquiring observed data indicating an observation result of a state of a robot capable of operating an object at a first time;
calculating a first feature amount at the first time based on the observed data at the first time using a first encoder;
calculating a second feature amount at the first time based on an action of the robot at a second time, a second feature amount at the second time, and the first feature amount at the first time using a recursive second encoder that holds the second feature amount at the second time prior to the first time;
determining an action of the robot at the first time on the basis of the second feature amount at the first time, and
learning at least the first encoder and the second encoder using contrastive learning.

9. A non-transitory storage medium that has stored a program for causing a computer to execute:
acquiring observed data indicating an observation result of a state of a robot capable of operating an object at a first time,
calculating a first feature amount at the first time based on the observed data at the first time using a first encoder,
calculating a second feature amount at the first time based on an action of the robot at a second time, a second feature amount at the second time, and the first feature amount at the first time using a recursive second encoder that holds the second feature amount at the second time prior to the first time,
determining an action of the robot at the first time on the basis of the second feature amount at the first time, and
learning at least the first encoder and the second encoder using contrastive learning.
